(19) United States
(12) Patent Application Publication
(10) Pub. No.: US 2026/0304109 A1
(43) Pub. Date: Oct. 1, 2026

(54) Datapath Architecture for Improved Mobility

(71) Applicant: Apple Inc., Cupertino, CA (US)

(72) Inventors: Naveen Kumar R Palle Venkata, San Diego, CA (US); Danila Zaev, Munich (DE); Onur Sahin, London (GB); Arnab Roy, San Diego, CA (US); Fangli Xu, Beijing (CN); Ayman F Naguib, Cupertino, CA (US); Satish Mardur, Munich (DE); Ralf Rossbach, Munich (DE)

(21) Appl. No.: 19/489,870

(22) PCT Filed: Jun. 25, 2023
(86) PCT No.: PCT/CN2023/102133

§ 371 Date: Dec. 3, 2025

(51) Int. Cl. H04W 12/033; H04W 12/04; H04W 36/00

(52) U.S. Cl. CPC H04W 12/033; H04W 36/0038; H04W 12/04

(57) ABSTRACT

This disclosure relates to techniques for establishing a data path with improved mobility features in a wireless communication system. A wireless device may establish a wireless link with an air-interface node of a cellular network. Cell-specific physical layer security coding may be performed for the wireless link between the wireless device and the air-interface node. User-plane termination may be established between the wireless device and a controller entity of the cellular network, which may be a cloud-deployed network function, via the wireless link. The wireless device may form user-plane uplink packets for the controller entity, and apply end-to-end security to generate encrypted user-plane uplink packets at a user-plane termination layer of the wireless device. The encrypted user-plane uplink packets may be provided to the controller entity via the wireless link with the air-interface node.

### FIELD

The present application relates to wireless communications, and more particularly to systems, apparatuses, and methods for establishing a data path with improved mobility features in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air-interfaces), LTE, LTE Advanced (LTE-A), NR, HSPA, 3GPP2 CDMA2000 (e.g., 1xRTT, 1xEV-DO, HRPD, eHRPD), IEEE 802.11 (WLAN or Wi-Fi), BLUETOOTH™, etc.

The ever-increasing range of features and functionality introduced in wireless communication devices also creates a continuous need for improvement in both wireless communications and in wireless communication devices. In particular, as wireless networks are expecting to handle increasing amounts of traffic, it is important to ensure that network architecture designs can effectively and efficiently handle that traffic. Accordingly, improvements in the field are desired.

### SUMMARY

Embodiments are presented herein of apparatuses, systems, and methods for establishing a data path with improved mobility features in a wireless communication system.

Establishing the data path may include providing user-plane termination layer functionality at a cloud-deployed controller entity of a cellular network, and at a corresponding user-plane termination layer of a wireless device served by the cellular network. This layer may provide end-to-end security for user-plane traffic between the wireless device and the cellular network in a manner transparent to air-interface nodes operated by the cellular network to provide radio access to the cellular network to the wireless device.

Additionally, techniques are described herein for handling physical layer security for communication on the radio link between such a wireless device and an air-interface node of the cellular network, in a manner that is based on cell-specific parameters and that can be performed independently for different air-interface node.

These techniques may be used to provide robust security and privacy in such a manner that mobility events, such as handover or cell re-selection, may be performed by a wireless device without transfer of security context between radio access network nodes. This may potentially lead to reduced mobility related signaling, and/or reduced mobility related interruptions and latency at wireless device in a cellular network, which could in turn lead to improved user experience, at least in some instances.

Note that the techniques described herein may be implemented in and/or used with a number of different types of devices, including but not limited to radio access network elements such as base stations, core network elements, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 illustrates an exemplary block diagram of a network element, according to some embodiments;

FIG. 6 is a flowchart diagram illustrating aspects of an exemplary possible method for establishing a data path with improved mobility features in a wireless communication system, according to some embodiments;

FIGS. 7-9 illustrate aspects of various possible network design and deployment scenarios that could be used in a cellular network that supports 6G based cellular communication, according to some embodiments;

FIGS. 10-11 illustrate example aspects of possible simplified data path architectures with features for providing improved mobility, according to some embodiments;

FIGS. 12-15 illustrate aspects of various simplified example protocol stacks that makes use of a data link layer, according to some embodiments; and

FIGS. 16-17 illustrate example aspects of possible physical layer security protection handling techniques, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
TRP: Transmission-Reception-Point

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well as any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

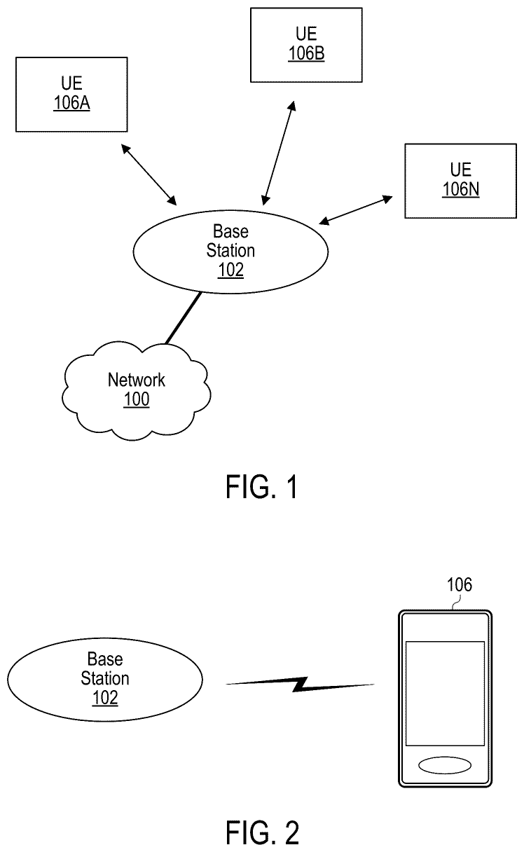

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. In some embodiments, it may be possible that the base station 102 includes 3GPP 6^{th} generation (6G) radio access network (RAN) node functionality. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

Note that, at least in some 3GPP contexts, base station functionality can be split, for example between any or all of centralized units (CUs), distributed units (DUs), and radio units (RUS). The illustrated base station 102 may support the functionality of any or all of a CU, a DU, or a RU, in such a network deployment context, at least according to some embodiments. In some instances, the base station 102 may be configured to act as an integrated access and backhaul (IAB) donor (e.g., including IAB donor CU and/or IAB donor DU functionality). In some instances, the base station 102 may be configured to act as an IAB node (e.g., including IAB mobile termination (MT) and IAB-DU functionality). Other implementations are also possible.

The base station 102 and the user devices may be configured to communicate over the transmission medium using any of various radio access technologies (RATs), also referred to as wireless communication technologies, or telecommunication standards, such as LTE, LTE-Advanced (LTE-A), LAA/LTE-U, 5G NR, Wi-Fi, etc. In some embodiments, at least some 3GPP 6G based communication techniques may be used to communicate over the transmission medium.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for establishing a data path with improved mobility features in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of LTE, LTE-A, 5G NR, Wi-Fi, BLUETOOTH™, or GNSS. In some embodiments, UE 106 may be capable of operating as a 3GPP 6G wireless device, or may potentially be capable of performing at least some 3GPP 6G based communication techniques. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or NR, and separate radios for communicating using each of Wi-Fi and BLUETOOTH™. Other configurations are also possible.

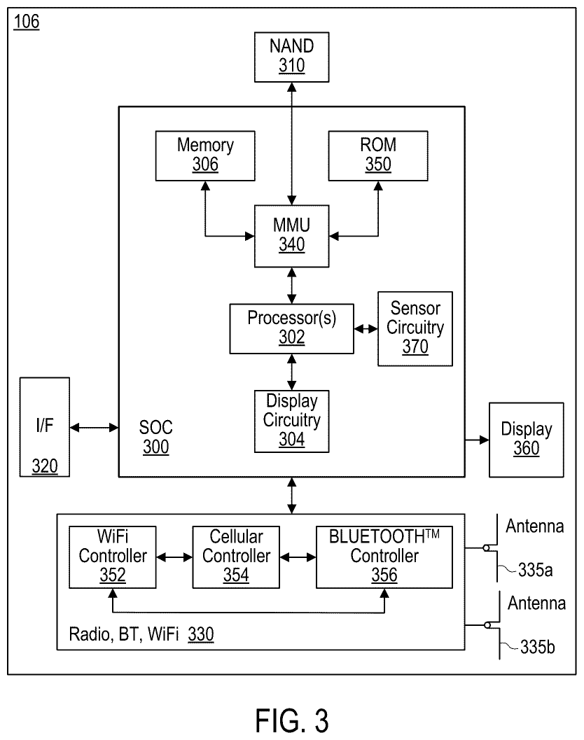

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. Some or all of the various illustrated components (and/or other device components not illustrated, e.g., in variations and alternative arrangements) may be “communicatively coupled” or “operatively coupled,” which terms may be taken herein to mean components that can communicate, directly or indirectly, when the device is in operation.

As shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, BLUETOOTH™, Wi-Fi, GPS, etc.). In some embodiments, UE 106 may be capable of operating as a 3GPP 6G wireless device, or may potentially be capable of performing at least some 3GPP 6G based communication techniques. The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques for establishing a data path with improved mobility features in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for establishing a data path with improved mobility features in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or NR controller) 354, and BLUETOOTH™M controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

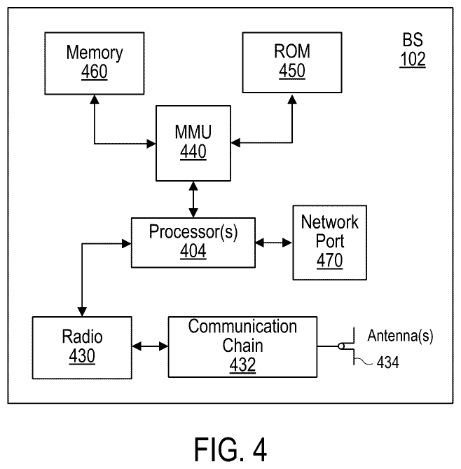

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs. In some embodiments, base station 102 may be capable of operating as a 3GPP 6G radio access network node, or may potentially be capable of performing at least some 3GPP 6G based communication techniques.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

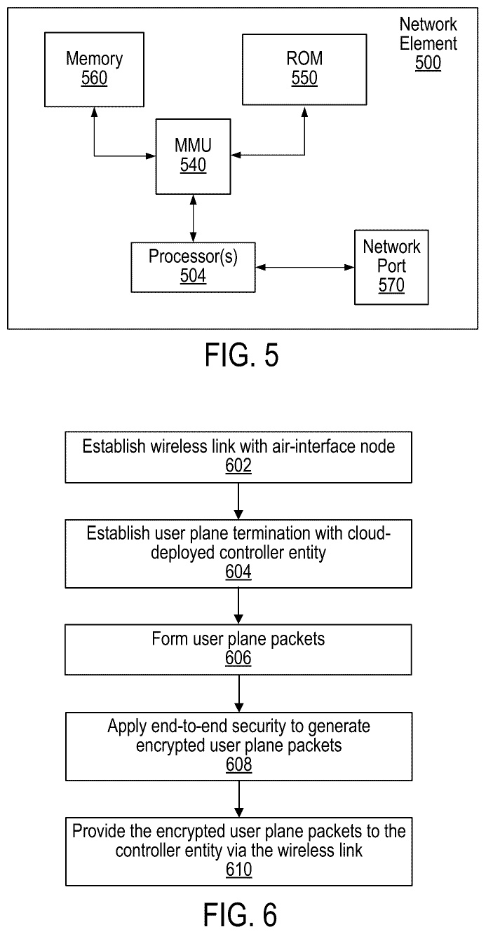

### FIG. 5—Exemplary Block Diagram of a Network Element

FIG. 5 illustrates an exemplary block diagram of a network element 500, according to some embodiments. According to some embodiments, the network element 500 may implement one or more logical functions/entities of a cellular core network, such as a mobility management entity (MME), serving gateway (S-GW), access and management function (AMF), session management function (SMF), etc. In some embodiments, network element 500 may be capable of operating as a 3GPP 6G network node, or may potentially be capable of performing at least some 3GPP 6G based communication techniques. It is noted that the network element 500 of FIG. 5 is merely one example of a possible network element 500. As shown, the core network element 500 may include processor(s) 504 which may execute program instructions for the core network element 500. The processor(s) 504 may also be coupled to memory management unit (MMU) 540, which may be configured to receive addresses from the processor(s) 504 and translate those addresses to locations in memory (e.g., memory 560 and read only memory (ROM) 550) or to other circuits or devices.

The network element 500 may include at least one network port 570. The network port 570 may be configured to couple to one or more radio access network elements and/or other cellular network entities and/or devices. The network element 500 may communicate with radio access network elements (e.g., eNBs/gNBs/etc.) and/or other network entities/ devices by means of any of various communication protocols and/or interfaces.

As described further subsequently herein, the network element 500 may include hardware and software components for implementing and/or supporting implementation of features described herein. The processor(s) 504 of the core network element 500 may be configured to implement or support implementation of part or all of the methods described herein, e.g., by executing program instructions stored on a memory medium (e.g., a non-transitory computer-readable memory medium). Alternatively, the processor 504 may be configured as a programmable hardware element, such as an FPGA (Field Programmable Gate Array), or as an ASIC (Application Specific Integrated Circuit), or a combination thereof.

### FIG. 6—Establishing a Data Path With Features for Providing Improved Mobility

As cellular communication technologies develop, it may be possible to more carefully select revised or new design features that can support more seamless mobility operations. One possible such set of design features may include a data path design that can provide security and privacy without requiring security context to be transferred between radio access network nodes when a wireless device undergoes mobility. FIG. 6 is a flowchart diagram illustrating a method for establishing such a data path with features for providing improved mobility in a wireless communication system, at least according to some embodiments.

Aspects of the method of FIG. 6 may be implemented by a wireless device, e.g., in conjunction with one or more cellular network elements, such as a UE 106, a BS 102, and/or network element 500 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 6 are described in a manner relating to the use of communication techniques and/or features associated with 3GPP specification documents, such description is not intended to be limiting to the disclosure, and aspects of the method of FIG. 6 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 6 may operate as follows.

In 602, the wireless device may establish a wireless link with an air-interface node. The air-interface node may be a radio access network node, such as a cellular base station, that provides an air-interface for communication between the wireless device and a cellular network. According to some embodiments, the wireless link may include a cellular link according to 5G NR. For example, the wireless device may establish a session with an AMF entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible (e.g., a 6G based cellular link), and the cellular network may also or alternatively operate according to another cellular communication technology, according to various embodiments.

In some embodiments, the wireless device may perform physical layer security coding for the wireless link between the wireless device and the air-interface node. The physical layer security coding may include any of various types of security coding, such as any or all of forward hashing, one or more scrambling methods, use of public or shared keys, etc. The physical layer security coding may be based on one or more cell-specific parameters, for example including a physical cell identifier (PCI). In some embodiments, the physical layer security coding may be based at least in part on one or more parameters that are specific to a beam for communication between the wireless device and the air-interface node (e.g., beam-specific parameters, such as beam identifier information). Note that the physical layer security coding may be used in either or both of the uplink (e.g., by the wireless device when transmitting to the air-interface node on the wireless link) or the downlink (e.g., by the air-interface node when transmitting to the wireless device on the wireless link), according to various embodiments.

According to various embodiments, the cell-specific parameters used for the physical layer security coding may be determined based at least in part on broadcast signaling information from the cellular network (e.g., from the air-interface node with which the wireless link is established or another air-interface node of the cellular network), or on dedicated signaling information from the air-interface node, or may be implicit (e.g., specified in 3GPP specifications, with the wireless device and the air-interface node each configured accordingly).

Note that, at least in some embodiments, the radio access network (RAN) of the cellular network may itself include multiple types of elements or nodes, for example including one or more centralized units (CUs), distributed units (DUs), and/or radio units (RUs), which may operate together to handle various aspects of RAN operation, such as providing an air-interface to wireless devices served by the RAN, control plane signal routing, user-plane signal routing, etc. Thus, at least in some instances, the wireless device establishing the wireless link with a RAN element that provides an air-interface may also support forming of one or more communication paths with other RAN elements in the cellular network, for example by way of the wireless link with the air-interface node.

As one such possibility, in 604, the wireless device and a controller entity of the cellular network may establish user-plane (UP) termination with each other via the wireless link between the air-interface node and the wireless device. The controller entity may be a cloud-deployed network function for the cellular network, such as a CU-UP entity capable of acting as a RAN controller for some or all of the cellular network. Terminating the UP at the wireless device and the controller entity may include establishing a data link layer (DLL) connection between the wireless device and the controller entity, in some embodiments; in this case, the DLL may function as a user-plane termination layer. The user-plane termination layer may provide data-link service operations, for example including acknowledged mode, unacknowledged mode, transparent mode, and/or other services. Thus, at least in some embodiments, the user-plane termination layer may provide packet recovery functionality. Quality of Service (QoS) functionality may additionally be provided at this user-plane termination layer, in some instances.

In 606, the wireless device may form UP uplink packets (e.g., DLL protocol data units (PDUs), as one possibility) for the controller entity at the user-plane termination layer (e.g., DLL) of the wireless device. In 608, the wireless device may also apply end-to-end security to the UP uplink packets to generate encrypted UP uplink packets at the user-plane termination layer of the wireless device. The encryption may be applied to the payload, and possibly to one or more headers (e.g., QoS headers), of the UP uplink packets. Forming and applying security to the UP uplink packets could include segmenting or concatenating higher layer (e.g., IP or application layer) packets, e.g., depending on the flow of incoming data from the higher layers. For example, an application packet might be too big for the UP termination layer to apply security, in which case the application packet could be segmented to allow the application of security. In 610, the wireless device may provide the encrypted UP uplink packets to the controller entity via the wireless link with the air-interface node.

Note that, similarly, the controller entity may form and apply end-to-end security to UP downlink packets (e.g., DLL PDUs) for the wireless device at the user-plane termination layer (e.g., DLL) of the controller entity. This could similarly include segmentation or concatentation of higher layer packets, and the encryption may be applied to the payload, and possibly to one or more headers (e.g., QoS headers), of the UP downlink packets. The controller entity may provide the encrypted UP downlink packets to the wireless device via the wireless link between the air-interface node and the wireless device.

The UP termination layer at each of the wireless device and the controller entity may also be capable of receiving and decrypting UP packets from the counterpart UP termination endpoint. Thus, the wireless device may receive encrypted user-plane downlink packets from the controller entity via the wireless link with the air-interface node, and decrypt those encrypted user-plane downlink packets at the user-plane termination layer of the wireless device. The controller entity may likewise receive encrypted user-plane uplink packets from the wireless device via the wireless link with the air-interface node, and decrypt those encrypted user-plane uplink packets at the user-plane termination layer of the controller entity.

Note that the end-to-end security connection established between the controller entity and the wireless device may apply for both access stratum (AS) and non-access stratum (NAS) domains, in some embodiments. As another possibility, the controller entity and the wireless device may establish separate end-to-end security contexts for the AS and NAS domains.

In some embodiments, at a lower layer (e.g., at the air-interface node and the wireless device), such as at a media access control (MAC) layer, it may be possible to perform segmentation and/or concatenation of the encrypted UP packets. Thus, prior to transmitting encrypted user-plane downlink packets to the wireless device, the air-interface node could perform segmenting of an encrypted user-plane downlink packet for the wireless device, e.g., at a MAC layer implemented by the air-interface node, and/or concatenating multiple encrypted user-plane downlink packets for the wireless device, e.g., at the MAC layer implemented by the air-interface node. Similarly, prior to transmitting encrypted user-plane uplink packets to the air-interface node, the wireless device could perform segmenting of an encrypted user-plane uplink packet, e.g., at a MAC layer implemented by the wireless device, and/or concatenating multiple encrypted user-plane uplink packets, e.g., at the MAC layer implemented by the wireless device.

Such segmentation or concatenation decisions may be handled independently for each node or wireless device, at least according to some embodiments. It may be the case that the air-interface node and the corresponding termination layer (e.g., MAC layer) at the wireless device do not participate in the end-to-end security application or peek into the encrypted UP packets, e.g., to base actions on any content within such packets. Such packets may be transmitted over-the-air without any specific packet recovery mechanism, in some embodiments, though retransmission of MAC transport blocks (which may include encrypted user-plane packets) via the wireless link may be performed based at least in part on air resource availability. As previously noted herein, a packet recovery mechanism may be implemented at the UP termination endpoints, in some embodiments.

In some embodiments, it may be possible for the controller entity to provide one or more encrypted user-plane downlink packets to multiple air-interface nodes for over-the-air transmission to the wireless device. This may occur due to wireless device mobility (e.g., to reduce the likelihood of packet loss during a transition from one air-interface node to another air-interface node, at the possible cost of redundancy), or in case a wireless device has established multiple wireless links with multiple air-interface nodes, among various possibilities. Since lower layer segmentation or concatenation decisions may be handled independently at each node, it may be possible that an encrypted user-plane downlink packets is segmented or concatenated differently at the different air-interface nodes prior to over-the-air transmission. Similarly, it could be possible that the wireless device performs over-the-air transmission of the same encrypted user-plane uplink packet to multiple air-interface nodes. The packet recovery mechanism implemented at the UP termination endpoints may be capable of detecting and discarding any duplicate UP termination layer packets received as a result of this, and/or of detecting and requesting retransmission of any missed UP termination layer packets, in some embodiments.

Note that given the physical layer security coding that may be applied on each wireless link between a wireless device and an air-interface node, which may be based on one or more cell-specific parameters, it may be possible that when a wireless device is in transmission or reception with multiple nodes, even if each node is transmitting/receiving the same UP termination layer packet, the MAC PDU/TB transmitted/received may differ due to the different physical layer security coding applied on the MAC PDU/TB. Thus, a scenario could occur in which the wireless device establishes a second wireless link with a second air-interface node of the cellular network, and performs physical layer security coding for the second wireless link based at least in part on one or more parameters specific to the second air-interface node. In this case, the wireless device could receive an encrypted user-plane downlink packet from one air-interface node in one MAC TB, and receive the encrypted user-plane downlink packet from the other air-interface node in another MAC TB, and the MAC TBs may differ due to the differing physical layer security coding being performed for the wireless links. Similarly, the wireless device could transmit an encrypted user-plane uplink packet to one air-interface node in one MAC TB, and transmit the encrypted user-plane uplink packet to the other air-interface node in another MAC TB, and the MAC TBs may differ due to the differing physical layer security coding being performed for the wireless links.

Since end-to-end security may be established between a wireless device and a cloud-based controller entity that could potentially manage a significant area, and physical layer security may be handled independently at least air-interface node in the cellular network, it may be the case that a wireless device can perform mobility without any need for the network to transfer security context information for the wireless device between RAN nodes. In other words, it may be possible for the wireless device to perform handover or cell re-selection to a different air-interface node, while keeping the same end-to-end security established with the controller entity in a manner transparent to the source and target air-interface nodes, and while separately and independently handling physical layer security procedures for each of the source and target air-interface nodes.

Thus, at least according to some embodiments, the method of FIG. 6 may be used to provide a framework according to which a wireless device may perform user-plane communication with a cellular network, in which security is provided without the need to transfer security context information between air-interface nodes to perform wireless device mobility events. This may reduce the amount of mobility signaling needed, and/or reduce the impact of interruptions from mobility on wireless devices, which may in turn benefit user experience, at least in some instances.

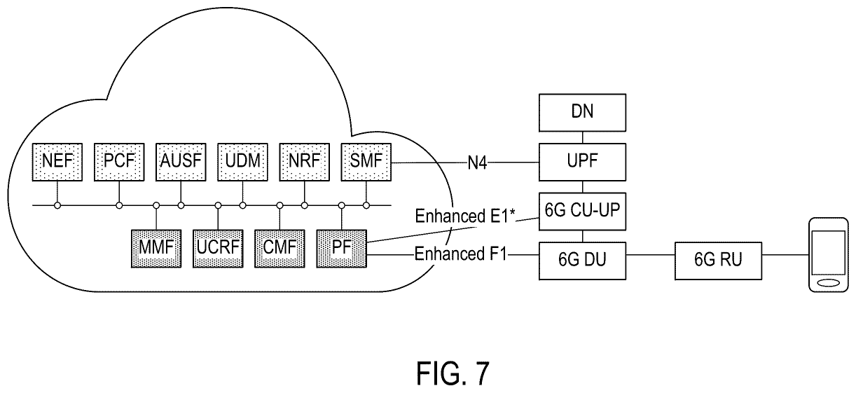

### FIGS. 7-17 and Additional Information

FIGS. 7-17 illustrate further aspects that might be used in conjunction with the method of FIG. 6 if desired. It should be noted, however, that the exemplary details illustrated in and described with respect to FIGS. 7-17 are not intended to be limiting to the disclosure as a whole: numerous variations and alternatives to the details provided herein below are possible and should be considered within the scope of the disclosure.

As cellular communication technology continues to be developed, potentially including in 3GPP 6G designs, it may be possible that a large number of network nodes can be specified and deployed in a cellular network, and that interactions with a UE could occur through many such nodes. Increasing the number of nodes may increase the total number of interactions, which may have the potential to increase the complexity of mobility operations. Accordingly, architecture design techniques that can proactively mitigate this potential complexity and support more seamless mobility may be desirable. Providing such techniques, preferably in a manner that does not compromise security and addresses privacy where applicable, may thus be a useful design goal, at least according to some embodiments.

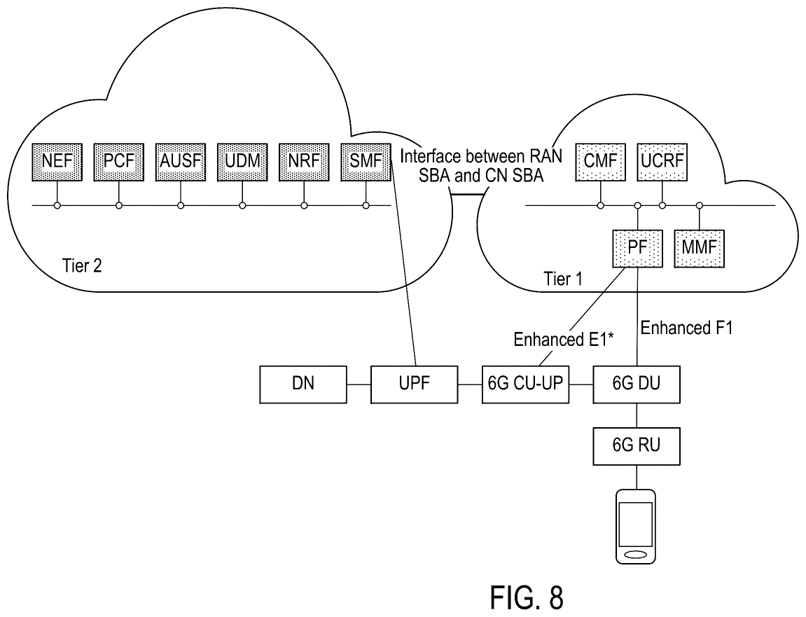

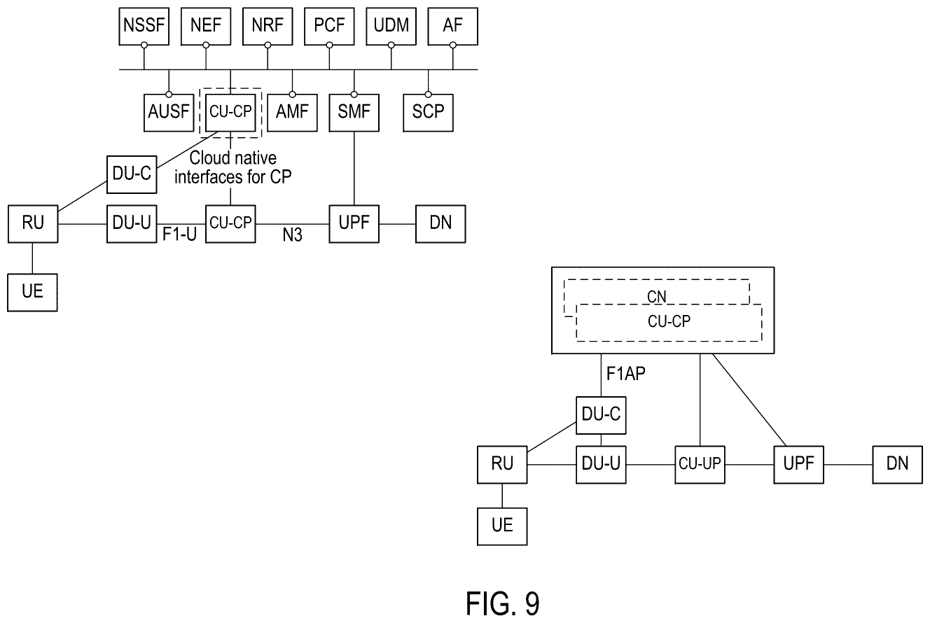

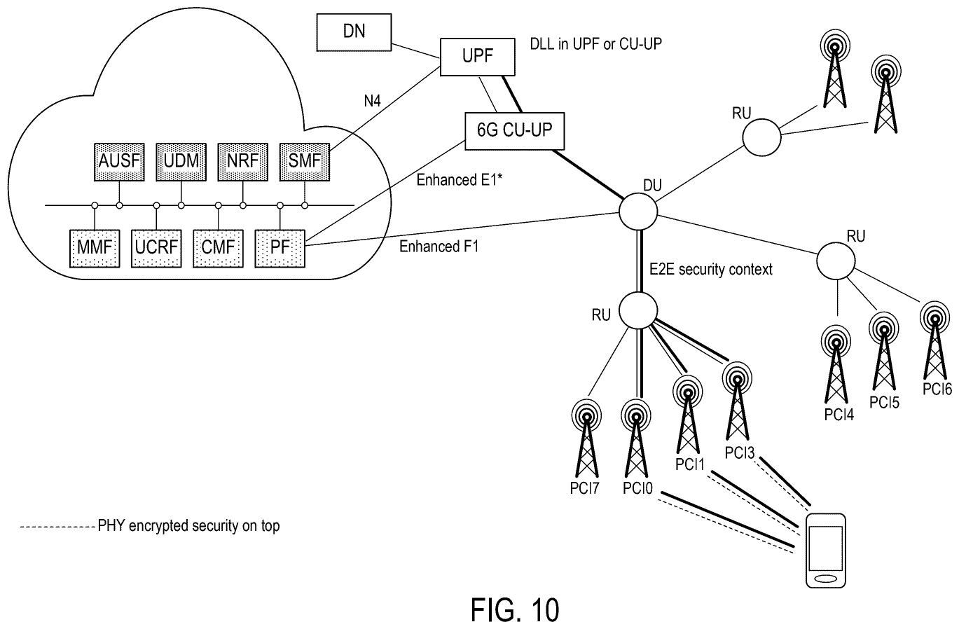

FIGS. 7-9 illustrate aspects of various possible network design and deployment scenarios that could be used in a cellular network that supports 6G based cellular communication, according to some embodiments. In particular, FIG. 7 illustrates a possible 1-tier deployment scenario, e.g., with single service-based architecture (SBA) deployment. As shown, various network functions (NFs), such as a network exposure function (NEF), policy control function (PCF), authentication server function (AUSF), unified data management (UDM), network repository function (NRF), session management function (SMF), mobility management function (MMF), UE context repository function (UCRF), connection management function (CMF), Proxy Function (PF), etc., may be deployed in a center cloud server, in the illustrated scenario. The cloud-based network functions may have interfaces with a user-plane function (UPF) (which in turn may interface with a data network (DN)), a 6G centralized unit-user-plane (CU-UP), and 6G distributed unit (DU), which may further be linked, by way of a 6G radio unit (RU), with a UE. FIG. 8 illustrates a possible 2-tier deployment scenario, e.g., with an interface between the radio access network (RAN) SBA and the core network (CN) SBA deployments. In this scenario, it may be the case that some NFs are deployed in a center cloud server, while other NFs may be deployed close to edge. FIG. 9 illustrates aspects of a scenario with further progression of RAN-CN convergence, in which the centralized unit-control plane (CU-CP) is cloud-based.

For seamless mobility, it may be preferable that interruptions/recovery from data packets across multiple nodes be minimized. At the same time, any data path changes may preferably be minimally or not impacted by the RAN-CN convergence discussions. Mobility latency/interruption may be heavily dependent on network nodes' interactions and operations. Security handling/switching may also be a critical factor in handling the requirements of data packets.

In view of such considerations, as one possible approach to datapath design, security handling may be moved into higher layers of the architecture (e.g., into the cloud). For example, it may be possible to have one level of end-to-end security as a service from 3GPP (e.g., instead of providing AS and NAS security contexts). Alternatively, it may be possible to maintain two levels of security (e.g., AS and NAS), with both being setup and handled from the cloud (e.g., which may host RAN and CN functions). User-plane traffic may then use the context of the security setup (with either the one layer or two layer option) for data packets.

Additionally, security measures may be provided at the physical layer, for example to provide some protection from eavesdropping and/or to enable UE detection of any tampering. Such measures could include integrity checking schemes and/or hashing schemes (e.g., using a public/private key architecture). Such security may be operated at a per-cell/TRP level, and independently for each cell/TRP. If the UE physical security context needed to be exchanged between nodes, mobility could potentially be severely impacted, and independent per-cell/TRP physical layer security measures may mean that no UE specific security context exchange is needed. The more the nodes are agnostic to upper layer security, the more seamless the UE mobility may be.

FIG. 10 illustrates example aspects of one possible simplified data path architecture for a single SBA deployment scenario, according to some embodiments. As shown, a data link layer (DLL) may terminate in either the UPF or CU-UP on the network side as well as at the UE. The DLL may be configured once per session in the CU, in some embodiments, and it may be the case that it does not change with mobility of the UE, as long as it is in the same CU, which may potentially cover a relatively large area. This may facilitate the DU/RU not needing to get any input from the CU; no dedicated UE information may need to be exchanged between nodes for security handling, and it may be transparent to the DU and RU. Note that it may be the case that the distinction between DU and RU can be implementation dependent. As also shown, it may be the case that PHY encrypted security may be used in addition to the end-to-end security context established in the DLL.

The end to end (E2E) security within the 6G system may be from the UE to the 6G controller, where the controller resides in the cloud, e.g., a centralized location which does not change with UE mobility, at least in some embodiments. It may be the case that a single security connection can be established for both AS and NAS domains. As another possibility, two security contexts can exist (e.g., for AS and for NAS), with both of them terminated in the cloud. Logical endpoints for these could be the same or different. Protection of physical layer transmission may be independent of the E2E security, and can include UE specific security, cell specific security, TRP level security, etc. This may help provide protection from eavesdropping and the ability to detect tampering.

The DLL may include the constructs for data-link service, for example including acknowledged mode (AM), unacknowledged mode (UM), transparent mode (TM), and/or other new services. The DLL may additionally implement/provide a level of Quality of Service (QOS). As previously noted, the end-points may reside in the cloud and at the terminal in the UE. The RAN may deliver the DLL packets without peeking into the content; it may be possible for the RAN to segment (or possibly concatenate), for example in sub-THz network deployment scenarios. Note that RAN segmentation may be independent of DLL segmentation, as DLL may for example segment based on other needs (e.g., maximum encryption size, as one possibility). The next generation 3GPP network may also have a medium access layer, for example to provide access across shared common channels. The E2E (upper layer) security may be originated at the DLL layer in the cloud.

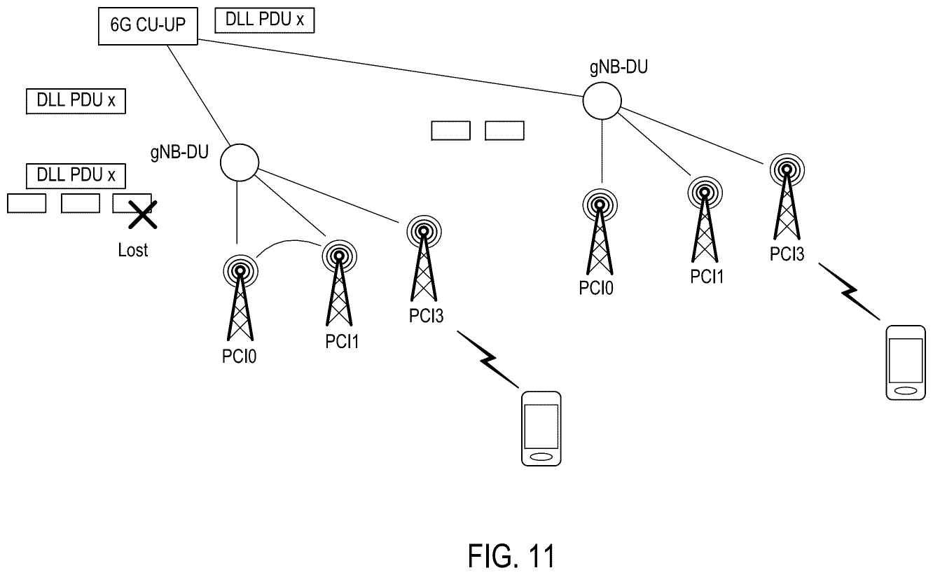

FIG. 11 illustrates further possible aspects of such a data path architecture, according to some embodiments. In the illustrated scenario, it may be possible that the same DLL protocol data unit (PDU) can be transmitted into the RAN on multiple nodes (e.g., if needed). The DLL PDU can be segmented at each DU/RU. It may be the case that there is no need to ‘recover’ the segments in the other DU, e.g., in case of mobility; the node that controls both, may need to transmit the same DLL PDU to both the source and target node, which while it may create redundancy, may reduce or avoid the potential for data interruption. In the illustrated scenario, the DU and RU may only deal with PHY configurations; for example, it may be the case that only DL (and UL) forward security derivation based on PCI (and other broadcasted/configured signaling) is performed.

Thus, it may be the case that the user-plane of a 6G wireless communication system terminates in the cloud. Packets may be formed at the UE (for uplink) and in the cloud end-point (for the downlink). Security may be applied at the end-points. It may be the case that air-interface nodes can segment or concatenate the packets, but do not handle security or peek into the packets to perform actions based on the content within the packets. It may be the case that air-interface node design is to transmit the packets under the design guidance that there is no need for recovery of the segmented/concatenated or untouched packets. For example, the recovery mechanism may be at the end-points (UE and the cloud); the air-interface may still be used for basic feedback-based transmission, for example using a hybrid automatic repeat request (HARQ) style in which the transport block (TB) can be re-transmitted based on air resource availability. Such operation may be unique to each air-interface node and the UE, in some embodiments.

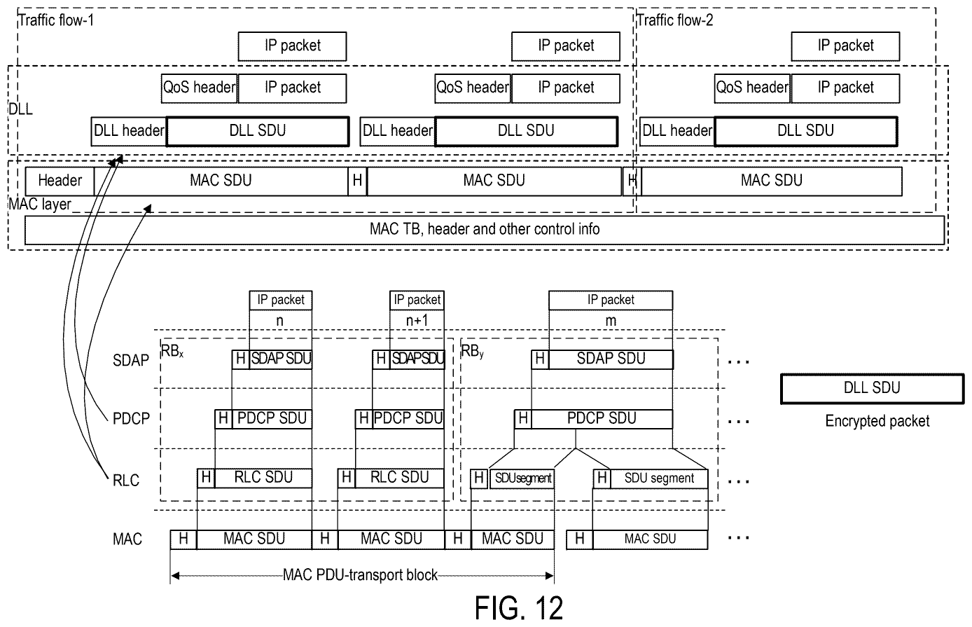

FIG. 12 illustrates a simplified view of an example protocol stack that makes use of a DLL, with functionality comparison to an example 5G protocol stack, according to some embodiments. As shown, IP packets may have QoS headers attached and be encrypted as a DLL service data unit (SDU), and the encrypted DLL SDUs may then have DLL headers attached, in the DLL. The MAC layer may receive the resulting DLL PDUs as MAC SDUS, attach MAC headers, and generate a MAC TB, with header and other control information. Note that as a variant, it may be also be possible that the QoS header is not encrypted.

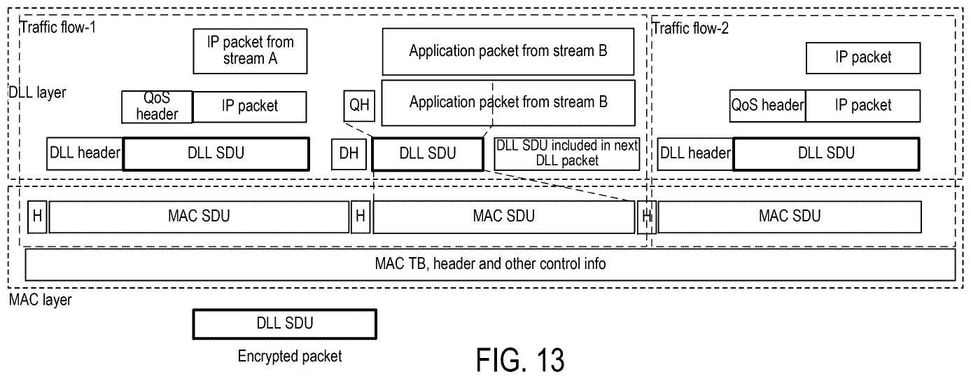

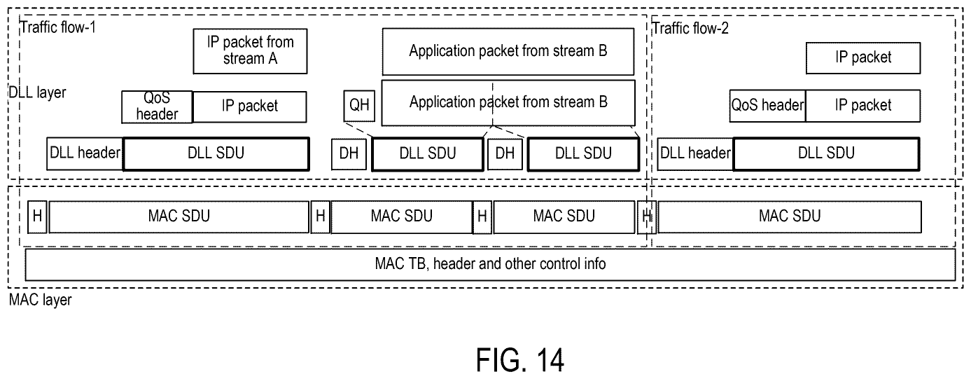

FIGS. 13-14 illustrate further example scenarios for a protocol stack that makes use of a DLL, according to some embodiments. In the illustrated examples, it may be the case that DLL can handle different types of application streams in one traffic flow (e.g., as an option, depending on QoS flow requirements). The packets from different applications in each flow can have different sizes, periodicities, etc. The DLL may optionally be able to segment/concatenate depending on the flow of incoming data from the above layers. For example, as shown, an application packet might be too big for the DLL to apply security, and so DLL may need to segment the packet to allow the application of security. Framing at DLL may be needed in this case. In the example scenario of FIG. 13, as shown, an application packet from “StreamB” may be segmented at the DLL into two DLL SDUs, one of which may be passed to the MAC layer for inclusion in the current MAC TB, while the other may be included in the next DLL packet. In the example scenario of FIG. 14, as shown, an application packet from StreamB may similarly be segmented at the DLL into two DLL SDUS, but both DLL SDUs may be passed to the MAC layer for inclusion in the current MAC TB.

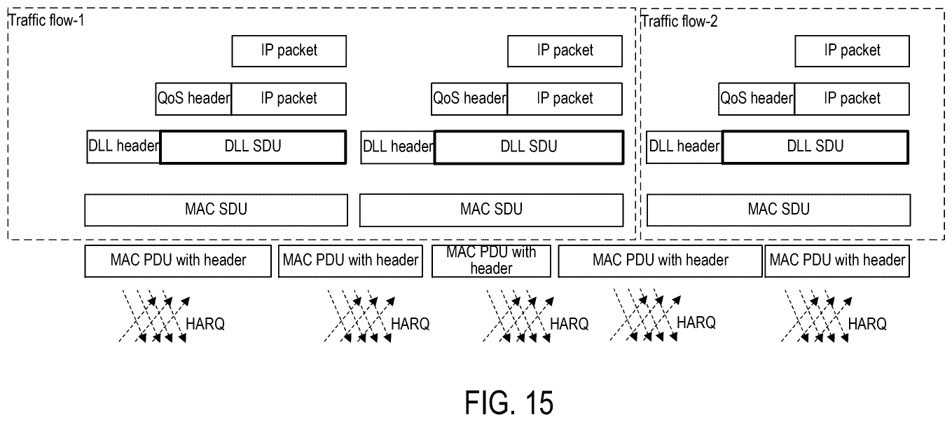

The DLL may perform security, sequencing, framing, and re-ordering. Its functionality may be part of the UPF (e.g., outside of the RAN, inside the backhaul, it can follow the evolved UPF), and part of the PDCP/SDAP and RLC functions of a 5G NR protocol stack can be moved into the DLL. The MAC layer (which can be restructured as upper/lower MAC, potentially without affecting functionality) may handle segmentation and concatenation of DLL SDUs (e.g., which could depend on uplink grants, in some embodiments). Sequencing may be needed/provided as an optional feature, e.g., depending on the service being provided (e.g., part of RLC functionality. In some embodiments, the operation may be similar to RLC UM mode. FIG. 15 further illustrates such possible MAC HARQ operation in conjunction with an example protocol stack that makes use of a DLL, according to some embodiments.

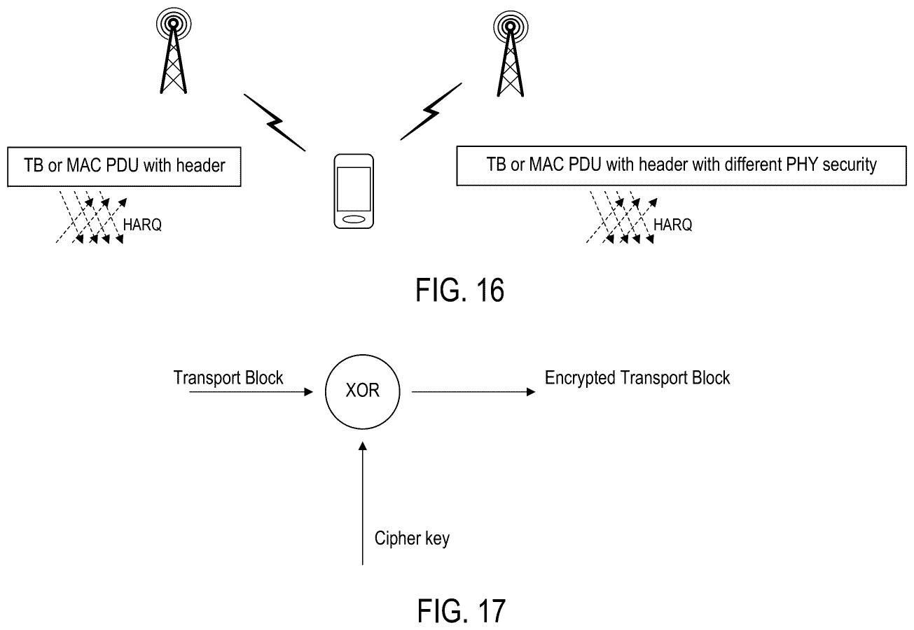

FIGS. 16-17 illustrate example aspects of possible physical layer security protection handling techniques, according to some embodiments. It may be the case that each TB is “security coded” based on the PCI of the cell, and/or additional cell specific parameters (e.g., beam specific parameters, for beam-based security). The UE may need to be aware of the parameters (e.g., without any additional dedicated signaling from the network, at least in some embodiments), for example since additional dedicated signaling may increase latency. The security coding could include forward hashing or any of various other possible schemes (e.g., a particular scrambling method, using public/shared keys, etc.), and may be used to prevent decoding of the packets easily by a third party, and/or to provide some signature protection to verify the source of the packets. Thus, as shown in FIG. 16, a UE could be in RX/TX with multiple nodes, and each node might be transmitting the same DLL PDU, but the MAC PDU/TB may be different due to the different “security code” applied on the TB. FIG. 17 illustrates how a TB could be combined with a cipher key to generate such an encrypted TB.

In the following further exemplary embodiments are provided.

One set of embodiments may include a method, comprising: by a wireless device: establishing a first wireless link with a first air-interface node of a cellular network; establishing user-plane termination with a controller entity of the cellular network via the first wireless link, wherein the controller entity is a cloud-deployed network function for the cellular network; forming user-plane uplink packets for the controller entity; applying end-to-end security to generate encrypted user-plane uplink packets at a user-plane termination layer of the wireless device; performing physical layer security coding for the first wireless link between the wireless device and the first air-interface node based at least in part on one or more cell-specific parameters; and providing the encrypted user-plane uplink packets to the controller entity via the first wireless link with the first air-interface node.

According to some embodiments, the user-plane termination layer is a data link layer (DLL), wherein establishing the user-plane termination with the controller entity includes configuring a DLL connection with the controller entity of the cellular network.

According to some embodiments, the physical layer security coding includes one or more of: forward hashing; one or more scrambling methods; or use of public or shared keys.

According to some embodiments, the physical layer security coding is further based at least in part on one or more parameters specific to a beam used for communication between the wireless device and the first air-interface node.

According to some embodiments, the method further comprises: determining one or more cell-specific parameters for the physical layer security coding based at least in part on broadcast signaling information from the cellular network.

According to some embodiments, the method further comprises: receiving encrypted user-plane downlink packets from the controller entity via the first wireless link with the first air-interface node; and decrypting the encrypted user-plane downlink packets at the user-plane termination layer of the wireless device.

According to some embodiments, the method further comprises: establishing a second wireless link with a second air-interface node of the cellular network; performing physical layer security coding for the second wireless link between the wireless device and the second air-interface node based at least in part on one or more cell-specific parameters; receiving an encrypted user-plane downlink packet from the first air-interface node in a first media access control (MAC) transport block (TB); and receiving the encrypted user-plane downlink packet from the second air-interface node in a second MAC TB, wherein the first MAC TB and the second MAC TB differ due to physical layer security coding being performed for the first wireless link with the first air-interface node and for the second wireless link with the second air-interface node based on different cell-specific parameters.

Another set of embodiments may include a method, comprising: by a controller entity of a cellular network which acts as a user-plane termination point, wherein the controller entity is a cloud-deployed network function for the cellular network: establishing user-plane termination with a wireless device via a wireless link between an air-interface node of the cellular network and the wireless device and one or more links between other radio access network nodes of the cellular network; forming user-plane downlink packets for the first wireless device; applying end-to-end security to downlink and uplink user-plane packets, including generating encrypted user-plane downlink packets; and providing the encrypted user-plane downlink packets to the wireless device via the wireless link between the air-interface node and the wireless device.

According to some embodiments, at least one encrypted user-plane downlink packet is provided to multiple air-interface nodes for over-the-air transmission to the wireless device.

According to some embodiments, the method further comprises: establishing an end-to-end security connection with the wireless device for both access stratum (AS) and non-access stratum (NAS) domains.

According to some embodiments, the method further comprises: establishing separate end-to-end security contexts with the wireless device for access stratum (AS) and non-access stratum (NAS) domains.

According to some embodiments, the method further comprises: receiving an encrypted user-plane uplink packet from the wireless device via the wireless link with the air-interface node; and decrypting the encrypted user-plane uplink packet at a user-plane termination layer of the controller entity.

Yet another set of embodiments may include a method, comprising: by an air-interface node of a cellular network: establishing a wireless link with a wireless device; receiving one or more encrypted user-plane downlink packets for the wireless device from a controller entity of the cellular network, wherein the controller entity is a cloud-deployed network function for the cellular network; and transmitting the one or more encrypted user-plane downlink packets to the wireless device via the wireless link using physical layer security coding based at least in part on one or more cell-specific parameters.

According to some embodiments, the method further comprises: providing information indicating the one or more cell-specific parameters via broadcast signaling.

According to some embodiments, the physical layer security coding is further based at least in part on one or more parameters specific to a beam used for communication between the wireless device and the air-interface node.

According to some embodiments, the physical layer security coding includes one or more of: forward hashing; one or more scrambling methods; or use of public or shared keys.

According to some embodiments, the method further comprises: receiving one or more encrypted user-plane uplink packets from the wireless device via the wireless link using physical layer security coding based at least in part on the one or more cell-specific parameters; and providing the one or more encrypted user-plane uplink packets to the controller entity of the cellular network.

According to some embodiments, the method further comprises: retransmitting the one or more encrypted user-plane downlink packets to the wireless device via the wireless link based at least in part on air resource availability.

According to some embodiments, the method further comprises, prior to transmitting the one or more encrypted user-plane downlink packets to the wireless device, performing one or more of: segmenting an encrypted user-plane downlink packet for the wireless device at a media access control (MAC) layer implemented by the air-interface node; or concatenating multiple encrypted user-plane downlink packets for the wireless device at the MAC layer implemented by the air-interface node.

Still another exemplary embodiment may include a device, comprising: one or more processors; and a memory having instructions stored thereon, which when executed by the one or more processors, perform steps of the method of any of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processor configured to cause a device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
by a wireless device:
establishing a first wireless link with a first air-interface node of a cellular network;
establishing user-plane termination with a controller entity of the cellular network via the first wireless link, wherein the controller entity is a cloud-deployed network function for the cellular network;
forming user-plane uplink packets for the controller entity;
applying end-to-end security to generate encrypted user-plane uplink packets at a user-plane termination layer of the wireless device;
performing physical layer security coding for the first wireless link between the wireless device and the first air-interface node based at least in part on one or more cell-specific parameters; and
providing the encrypted user-plane uplink packets to the controller entity via the first wireless link with the first air-interface node.

2. The method of claim 1,
wherein the user-plane termination layer is a data link layer (DLL), wherein establishing the user-plane termination with the controller entity includes configuring a DLL connection with the controller entity of the cellular network.

3. The method of claim 1, wherein the physical layer security coding includes one or more of:
forward hashing;
one or more scrambling methods; or
use of public or shared keys.

4. The method of claim 1,
wherein the physical layer security coding is further based at least in part on one or more parameters specific to a beam used for communication between the wireless device and the first air-interface node.

5. The method of claim 1, wherein the method further comprises:
determining one or more cell-specific parameters for the physical layer security coding based at least in part on broadcast signaling information from the cellular network.

6. The method of claim 1, wherein the method further comprises:
receiving encrypted user-plane downlink packets from the controller entity via the first wireless link with the first air-interface node; and
decrypting the encrypted user-plane downlink packets at the user-plane termination layer of the wireless device.

7. The method of claim 1, wherein the method further comprises:
establishing a second wireless link with a second air-interface node of the cellular network;
performing physical layer security coding for the second wireless link between the wireless device and the second air-interface node based at least in part on one or more cell-specific parameters;
receiving an encrypted user-plane downlink packet from the first air-interface node in a first media access control (MAC) transport block (TB); and
receiving the encrypted user-plane downlink packet from the second air-interface node in a second MAC TB, wherein the first MAC TB and the second MAC TB differ due to physical layer security coding being performed for the first wireless link with the first air-interface node and for the second wireless link with the second air-interface node based on different cell-specific parameters.

8. An apparatus configured to implement a controller entity of a cellular network which acts as a user-plane termination point, wherein the controller entity is a cloud-deployed network function for the cellular network, the apparatus comprising a processor and memory configured to cause the processor to:
establish user-plane termination with a wireless device via a wireless link between an air-interface node of the cellular network and the wireless device and one or more links between other radio access network nodes of the cellular network;
form user-plane downlink packets for the first wireless device;
apply end-to-end security to downlink and uplink user-plane packets, including generating encrypted user-plane downlink packets; and
provide the encrypted user-plane downlink packets to the wireless device via the wireless link between the air-interface node and the wireless device.

9. The apparatus of claim 8,
wherein at least one encrypted user-plane downlink packet is provided to multiple air-interface nodes for over-the-air transmission to the wireless device.

10. The apparatus of claim 8, wherein the memory is further configured to cause the processor to:
establish an end-to-end security connection with the wireless device for both access stratum (AS) and non-access stratum (NAS) domains.

11. The apparatus of claim 8, wherein the memory is further configured to cause the processor to:
establish separate end-to-end security contexts with the wireless device for access stratum (AS) and non-access stratum (NAS) domains.

12. The apparatus of claim 8, wherein the memory is further configured to cause the processor to:
receive an encrypted user-plane uplink packet from the wireless device via the wireless link with the air-interface node; and
decrypt the encrypted user-plane uplink packet at a user-plane termination layer of the controller entity.

13. A
base station configured to act as an air-interface node of a cellular network, comprising:
one or more antennas;
one or more radios operably coupled to the one or more antennas; and
a processor operably coupled to the one or more radios;
wherein the base station is configured to:
establish a wireless link with a wireless device;
receive one or more encrypted user-plane downlink packets for the wireless device from a controller entity of the cellular network, wherein the controller entity is a cloud-deployed network function for the cellular network; and
transmit the one or more encrypted user-plane downlink packets to the wireless device via the wireless link using physical layer security coding based at least in part on one or more cell-specific parameters.

14. The base station method of claim 13, wherein the base station is further configured to:
provide information indicating the one or more cell-specific parameters via broadcast signaling.

15. The base station of claim 13,
wherein the physical layer security coding is further based at least in part on one or more parameters specific to a beam used for communication between the wireless device and the air-interface node.

16. The base station of claim 13, wherein the physical layer security coding includes one or more of:
forward hashing;
one or more scrambling methods; or
use of public or shared keys.

17. The base station of claim 13, wherein the base station is further configured to:
receive one or more encrypted user-plane uplink packets from the wireless device via the wireless link using physical layer security coding based at least in part on the one or more cell-specific parameters; and
provide the one or more encrypted user-plane uplink packets to the controller entity of the cellular network.

18. The base station of claim 13, wherein the base station is further configured to:
retransmit the one or more encrypted user-plane downlink packets to the wireless device via the wireless link based at least in part on air resource availability.

19. The base station of claim 13, wherein prior to transmitting the one or more encrypted user-plane downlink packets to the wireless device, the base station is further configured to:
segment an encrypted user-plane downlink packet for the wireless device at a media access control (MAC) layer implemented by the air-interface node.

20. (canceled)

21. The base station of claim 13, wherein prior to transmitting the one or more encrypted user-plane downlink packets to the wireless device, the base station is further configured to:
concatenate multiple encrypted user plane downlink packets for the wireless device at the MAC layer implemented by the air interface node.
